(19) United States
(12) Patent Application Publication
(10) Pub. No.: US 2009/0158215 A1
(43) Pub. Date: Jun. 18, 2009

(54) INPUT APPARATUS, IMAGE FORMING APPARATUS USING THE SAME AND METHOD THEREOF

(75) Inventors: Kwang-soo Ha, Seoul (KR); Tae-hoi Do, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/254,995

(22) Filed: Oct. 21, 2008

(30) Foreign Application Priority Data
Dec. 17, 2007 (KR) 2007-132419

(51) Int. Cl. G06F 3/048

(52) U.S. Cl. 715/834

(57) ABSTRACT

An image forming apparatus through which a user inputs characters using a rotatable search wheel. The image forming apparatus includes a display unit to display a character set in order to input characters, a search wheel, which is able to rotate, to search for characters to be input from the displayed character set while being rotated, an input button to select the characters searched by the search wheel and to input the selected characters, and a control unit to display on the display unit characters selected from the displayed character set according to a rotation direction of the search wheel. Therefore, it is possible to input characters more conveniently and rapidly.

### CROSS-REFERENCE TO RELATED APPLICATIONS

This application claims priority under 35 U.S.C. §119(a) from Korean Patent Application No. 10-2007-0132419, filed on Dec. 17, 2007, in the Korean Intellectual Property Office, the disclosure of which is incorporated herein by reference in its entirety.

### BACKGROUND OF THE INVENTION

1. Field of the Invention

The present general inventive concept relates to an input apparatus and an image forming apparatus including the input apparatus, and a method thereof. More particularly, the present general inventive concept relates to an input apparatus through which a user may input characters using a rotatable search wheel and to an image forming apparatus including the input apparatus, and to a method thereof.

2. Description of the Related Art

Display apparatuses provide various methods for inputting characters, including, a result of the development of application software, a method for inputting characters using a soft keyboard.

Soft keyboards refer to image keyboards in which consonants and vowels are arranged in the same manner as in general keyboards. Soft keyboards are displayed on display screens, which enable users to conveniently enter characters. In particular, if a soft keyboard is displayed on a display screen, a user may input desired characters or numbers using a user input apparatus or device such as a remote control unit or a joystick.

However, since a conventional soft keyboard has the same layout as a general keyboard connected to a computer, a large number of keys need to be displayed on a single screen, so a conventional soft keyboard occupies most of the screen. Accordingly, it is impossible to display information regarding environment in which character input is required, so it is difficult for the user to be sure that he or she has accurately input the desired characters.

Additionally, if a user desires to input characters using a control apparatus, keys used to input the characters are spaced apart on a keyboard, so it is required for keys of the control apparatus to move a distance in which the keys of the keyboard are spaced apart. Furthermore, since the keys of the keyboard are not arranged sequentially, the user may experience inconvenience when manipulating directional keys to search for a desired character or select the desired character.

General soft keyboards occupy a wide area of a display screen, making it hard to use such a soft keyboard in a display apparatus having a small screen and causing user inconvenience.

Therefore, there is a need for a method whereby characters may be input smoothly and rapidly while using a small area of the display screen.

### SUMMARY OF THE INVENTION

The present general inventive concept provides an input apparatus to rapidly input characters using a rotatable search wheel, and an image forming apparatus using the input apparatus, and a method thereof.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming apparatus including a display unit to display a character, a search wheel selectable and rotatable, to receive selection, rotation, or selection and rotation input to search for characters to be input from the displayed character set, an input button, and a control unit to receive a selection of a character from the displayed character set from the input button.

The image forming apparatus may further include at least one selection button disposed on one side of the display unit. If the at least one selection button is selected, the control unit may control at least one function corresponding to the selected button to be actuated.

If the search wheel receives rotation input that is out of a range of a character set, the control unit may control the display unit to display the character set cyclically, or to display another character set.

If a plurality of character sets are displayed, the control unit may control the display unit so that a display state of a currently selected character set may differ from those of other character sets.

The image forming apparatus may further include a directional key that receives input for directional movement. If a plurality of character sets are displayed and if the directional key is manipulated, the control unit may control the display unit so that the currently selected character set may change to another character set according to the manipulation of the directional key.

The image forming apparatus may further include a state indicating unit having a plurality of luminous elements arranged along an outer edge of the search wheel to display feedback corresponding to the manipulation of the search wheel.

The character set may include a plurality of character sets in which characters are combined into groups in a predetermined order for each respective script.

The control unit may control the display unit to display a set of domain names in which preset domain names are arranged to receive input of an e-mail address.

The foregoing and/or other aspects and utilities of the present general inventive concept may also be achieved by providing a character input apparatus including a display unit to display a character set, a search wheel selectable and rotatable, to receive selection, rotation, or selection and rotation input to search for characters in the displayed character set, and an input button to receive an input selection of the characters selected by the search wheel.

The character input apparatus may further include at least one selection button disposed on one side of the display unit. If the at least one selection button is selected, the display unit may display at least one function to be actuated corresponding to the selected button.

The display unit may display characters contained in a character set corresponding to a rotation direction of the search wheel.

If the search wheel receives rotation input out of a range of a character set, the display unit may display the character set cyclically, or display another character set.

The display unit may display a plurality of character sets so that a display state of a currently selected character set may differ from those of other character sets.

The character input apparatus may further include a directional key for directional movement. If a plurality of character sets are displayed and if the directional key is selected, the display unit may change the currently selected character set to another character set in a direction of the selected directional key.

The character input apparatus may further include a state indicating unit having a plurality of luminous elements along an outer edge of the search wheel to display feedback corresponding to the manipulation of the search wheel.

The character set may include a plurality of character sets in which characters are combined into groups in a predetermined order for each respective script.

The foregoing and/or other aspects and utilities of the present general inventive concept may also be achieved by providing a method of inputting characters using a search wheel, the method including displaying a character set in order to input characters, searching for characters from a character set corresponding to the manipulation of the search wheel, and receiving an input selection of the characters by the search wheel.

The method may include if the search wheel rotates out of a range of a character set, displaying the character set cyclically, or displaying another character set.

The method may include receiving a selection of a directional key, and changing a currently displayed character set to another character set.

The method may include displaying a plurality of character sets so that a display state of a currently selected character set may differ from those of other character sets.

The method may further include determining a display pattern corresponding to the manipulation of the search wheel, and displaying feedback regarding the manipulation of the search wheel by controlling the illumination of a plurality of luminous elements arranged along an outer edge of the search wheel.

The character set may include a plurality of character sets in which characters are combined into groups in a predetermined order for each respective script.

The foregoing and/or other aspects and utilities of the present general inventive concept may also be achieved by providing a computer recording medium having recorded thereon a program to implement a method of inputting characters using a search wheel, the method including displaying a character set in order to input characters, searching for characters from a character set corresponding to manipulation of the search wheel, and receiving an input selection of the characters by the search wheel.

The foregoing and/or other aspects and utilities of the present general inventive concept may also be achieved by providing a character input apparatus, the apparatus including a search wheel to receive selection, rotation, or selection and rotation input to search for one or more characters displayed on a display, and a control unit to receive a selection of a character from the search wheel.

The character input apparatus may further include a state indicating unit having one or more illumination devices to illuminate based on the received selection, rotation, or selection and rotation input from the search wheel.

The foregoing and/or other aspects and utilities of the present general inventive concept may also be achieved by providing a display apparatus, the apparatus including a display screen to display a character set, a search wheel to receive selection, rotation, or selection and rotation input to search for one or more characters displayed on a display, and a control unit to receive a selection of a character from the search wheel.

The apparatus may further include one or more buttons that receive a selection based on at least one message displayed on the display screen, wherein the control unit receives the selection and controls an operation of the display apparatus based on the selection.

The apparatus may further include a state indicating unit having one or more illumination devices to illuminate based on the received selection, rotation, or selection and rotation input from the search wheel.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIGS. 1 and 2 illustrate block diagrams of an input apparatus according to an exemplary embodiment of the present general inventive concept;

FIGS. 3A to 3C illustrate search wheel and state indicating unit according to exemplary embodiments of the present general inventive concept;

FIG. 4 illustrates a block diagram of an image forming apparatus according to an exemplary embodiment of the present general inventive concept;

FIG. 5 exemplarily illustrates the input apparatus of FIG. 2;

FIGS. 6 to 9 are exemplary views illustrating a method of inputting characters according to exemplary embodiments of the present general inventive concept; and

FIG. 10 is a flowchart illustrating a method of inputting characters according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

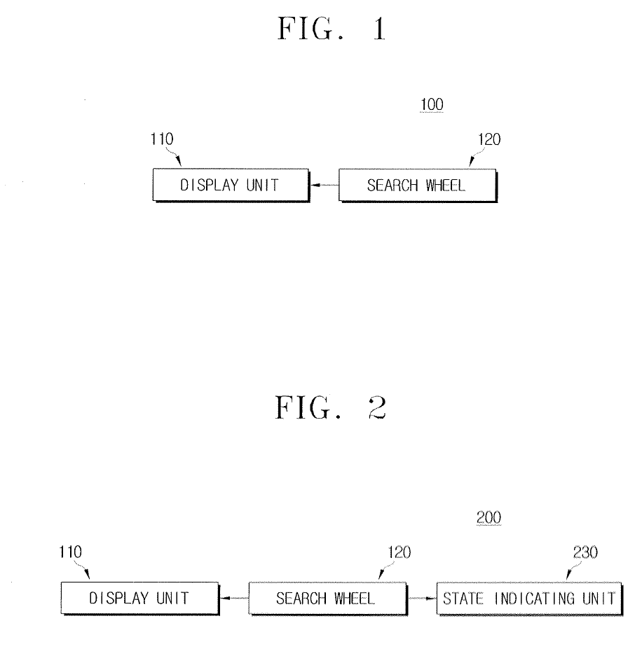

FIG. 1 is a block diagram of a character input apparatus 100 according to an exemplary embodiment of the present general inventive concept. The character input apparatus 100 of FIG. 1 includes a display unit 110 and a search wheel 120. Character input apparatus 100 may have utility in any suitable device where alpha-numeric input for the device is desirable.

If various functions of apparatuses having character input apparatus 100 receive character input, the display unit 110 displays a plurality of character sets in which characters are arranged in a predetermined order. In this situation, the display unit 110 displays the character sets as an image map in the form of a soft keyboard. The display unit 110 may be implemented as a liquid crystal display (LCD). Alternatively, the display unit 110 may be implemented as a cathode-ray tube (CRT), plasma display panel (PDP), or organic light emitting diodes (OLED), or any other suitable display.

The display unit 110 may include a plurality of buttons (not illustrated) on one side thereof. Additionally, the display unit 110 may display a plurality of functions, where one or more functions may be executed by selecting one or more of the buttons, on a display area corresponding to the selected one or more buttons. Such functions may be set by the user, or may be predetermined based on the apparatus that character input apparatus 100 is communicatively coupled with. Accordingly, the user may change various functions and set the changed functions to a single button or to a plurality of buttons. The display unit 110 may display how tasks are processed when the one or more buttons are selected.

The search wheel 120 enables a user to select characters displayed on the display unit 110. The search wheel 120 refers to a rotatable input means, such as a 360° rotary wheel, a jog shuttle or a jog dial. Rotation of the search wheel 120 may allow one or more characters or symbols to be selected. The user may thereby select desired characters on the display unit 110 while rotating the search wheel 120. The search wheel 120 may include various selection buttons, or the entire area of the search wheel 120 may be set to be a touch sensing area. Accordingly, the user may push the search wheel 120 rather than rotate the search wheel 120 in order to select characters. Additionally, the search wheel 120 may include push areas on at least a portion thereof, and the push areas may be used as directional keys for multi-directional movement.

The character input apparatus 100 may further include an input button (similar to input button 125 illustrated in FIG. 5). The input button enables the user to input characters selected using the search wheel 120. The input button may be formed separately from or formed integrally with the search wheel 120.

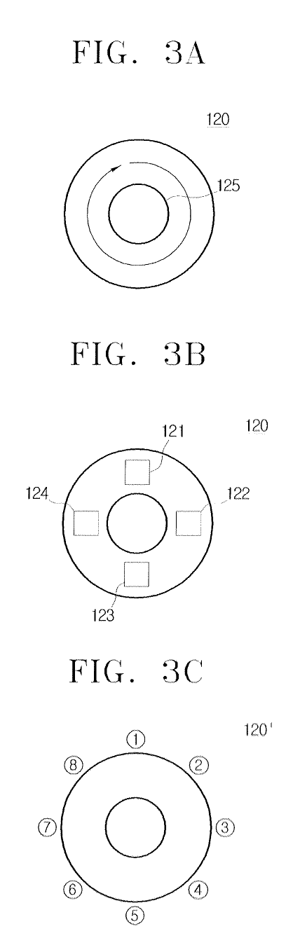

FIG. 2 is a block diagram of a character input apparatus 200 according to another exemplary embodiment of the present general inventive concept. The character input apparatus 200 of FIG. 2 includes a display unit 110, a search wheel 120 and a state indicating unit 230. The display unit 110 and search wheel 120 have been described above with reference to FIG. 1, so overlapping description thereof is omitted.

The state indicating unit 230 may present a display pattern that corresponds to the manipulation on the search wheel 120, for example, to provide a feedback to a user inputting movement to the search wheel 120.

The state indicating unit 230 may be implemented as a plurality of luminous elements arranged along an outer edge of the search wheel 120. The luminous elements for converting electricity into light may include light-emitting diodes (LEDs), or any other light emitting devices. Hereinafter, LEDs will be used as luminous elements in order to facilitate understanding of the present general inventive concept.

A plurality of LEDs of the state indicating unit 230 may be arranged at predetermined intervals outside or inside of an edge of the state indicating unit 230. For example, the LEDs may be in an arrangement that corresponds to the vertices of a square or polygon. Alternatively, a transparent sheet (not illustrated) may be arranged over the LED module to express a plurality of LEDs continuously, that is, without boundaries of light.

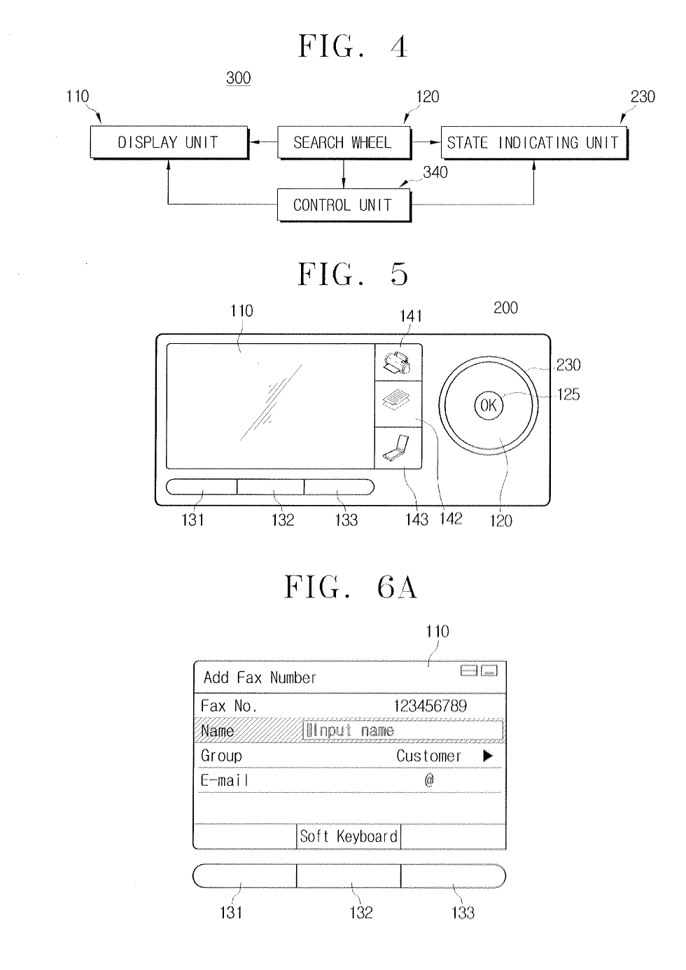

FIGS. 3A to 3C illustrate the search wheel 120 and the state indicating unit 230 according to exemplary embodiments of the present general inventive concept.

In FIG. 3A, the search wheel 120 may rotate in a direction indicated by an arrow in FIG. 3A (clockwise), or rotate in a reverse direction (counterclockwise) based at least in part on received directional input. FIG. 3A exemplarily illustrates a situation in which the search wheel 120 is formed integrally with an input button 125. The input button 125 is disposed in the center of the search wheel 120. Accordingly, after rotating the search wheel 120 and selecting a desired character or character set, the user may input the selected character or character set by pushing the input button 125. As described above, the search wheel 120 may thus be operated either by rotation or selection.

In FIG. 3B, the search wheel 120 may include at least at least one area designated as a push areas, such as push areas 121, 122, 123, and 124. For example, in this exemplary embodiment of the present general inventive concept, the four push areas 121 to 124 are disposed on upper, lower, left and right portions of the search wheel 120 to be used as directional keys by which the user may input a multi-directional movement command. The number and location of the push areas may be adjusted.

FIG. 3C exemplarily illustrates a search wheel 120′ combined with a plurality of LEDs.

In FIG. 3C, a plurality of LEDs #1, #2, #3, #4, #5, #6, #7, and #8 are arranged along the outer edge of the search wheel 120′ at predetermined intervals. The plurality of LEDs #1 to #8 may be provided in an arrangement that corresponds to the vertices of octagon. However, any number of LEDs may be provided in a suitable geometric arrangement.

FIG. 4 is a block diagram of an image forming apparatus 300 including the character input apparatus 200, according to an exemplary embodiment of the present general inventive concept. The image forming apparatus 300 of FIG. 4 includes a display unit 110, a search wheel 120, a state indicating unit 230, a control unit 340 and an input button (similar to input button 125 illustrated in FIG. 5). The display unit 110, search wheel 120 and state indicating unit 230 have been described above with reference to FIGS. 1 and 2, so overlapping description thereof is omitted.

An image forming apparatus including the character input apparatus 100 of FIG. 1 has the same configuration as the image forming apparatus 300 including the character input apparatus 200, except for the state indicating unit 230, so only the image forming apparatus 300 including the character input apparatus 200 will hereinafter be described in this exemplary embodiment of the present general inventive concept. The image forming apparatus 300 may be a printer, a scanner, a multifunctional peripheral, a copier or a facsimile machine.

The display unit 110 displays a menu and messages regarding various functions provided by the image forming apparatus 300. Additionally, if it is desirable to receive character input to execute a task, the display unit 110 may display a plurality of character sets in which characters are arranged for a user to select.

The search wheel 120 is rotatable in a clockwise or counterclockwise direction, and may be used to navigate menus on the display unit 110 upon receiving rotational input. Additionally, the search wheel 120 enables to the user to select characters from each of the displayed plurality of character sets. As described above, since the search wheel 120 includes one or more directional keys or an input button, any selection can be made.

The control unit 340 receives selection of a character set from the displayed plurality of character sets on display unit 110 according to the rotation direction of the search wheel 120 to be displayed. Each character may be sequentially displayed every time the characters are selected, or only a word or syllable is displayed after all characters have been selected. Additionally, if the search wheel 120 rotates out of a range of a character set, the control unit 340 may control the display unit 110 to display the character set cyclically, or to display another character set, or any other suitable information, such as a marker identifying the end of displayable character sets.

If the user selects one key from among the directional keys on the search wheel 120, the control unit 340 may control the display unit 110 so that a currently displayed character set may change to another character set in a direction indicated by the selected key, and that the new character set may be displayed.

The plurality of character sets may be provided in which characters are combined into groups in a predetermined order for each respective script. Character sets may be for one or more languages (e.g., English, Korean, Japanese, Chinese, Russian, Arabic, etc.).

For example, a plurality of Korean character sets may be displayed which include a first character set, a second character set and a third character set. The first character set may include characters which may occur in an initial position, the second character set may include characters which may occur in a medial position, and the third character set may include characters which may occur in a final position. Accordingly, characters selected from the first to third character sets may be input to form a single Korean syllable.

Alternatively, a plurality of Korean character sets may be displayed including a first character set in which Korean consonants are sequentially arranged, and a second character set in which Korean vowels are sequentially arranged.

Additionally, a plurality of English character sets may be displayed which include a first character set containing upper case letters, and a second character set containing lower case letters. In the case of Chinese characters, a plurality of character sets may be displayed in which characters are arranged according to their radical, or according to a pronunciation. Additionally, in the case of Japanese kana characters, a plurality of character sets may be displayed which include a hiragana character set and a katakana character set.

Besides, it is possible to display any word comprising characters which are able to be arranged in a predetermined arrangement order.

For example, a character set may include Greek or special character sets, or number sets.

Additionally, if the user needs to input an e-mail address during task execution, the display unit 110 may display a set of domain names on a soft keyboard.

FIG. 5 exemplarily illustrates the character input apparatus 200 of FIG. 2. If the state indicating unit 230 is omitted from the character input apparatus 200 of FIG. 5, the character input apparatus 100 of FIG. 1 can be formed.

In FIG. 5, the display unit 110 and the state indicating unit 230 are disposed on the left and right of the character input apparatus 200, respectively. A plurality of LEDs of the state indicating unit 230 are arranged along the outer edge of the search wheel 120. A plurality of buttons 131, 132, and 133 are disposed on a lower portion of the display unit 110, and a function to be executed when at least one button is selected from among the plurality of buttons 131 to 133 may be displayed on one area of the display unit 110 corresponding to the plurality of buttons 131 to 133.

Additionally, function keys 141, 142, and 143 may be selected to perform one or more functions (for example, outputting, facsimile transmission or scanning functions) which can be executed by the image forming apparatus are displayed on the right of the display unit 110.

Furthermore, the input button 125 to select characters indicated by a cursor displayed on the display unit 110 is disposed on the center of the search wheel 120.

Hereinafter, various exemplary embodiments of the present general inventive concept using the character input function of the image forming apparatus 300 will be described.

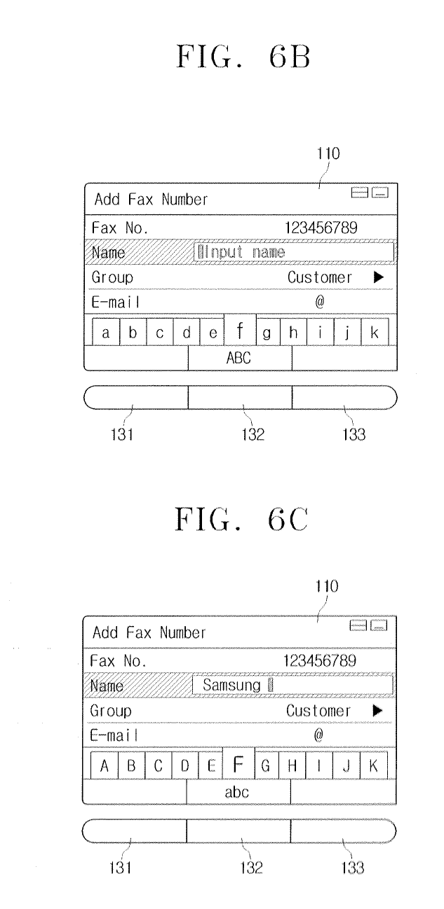

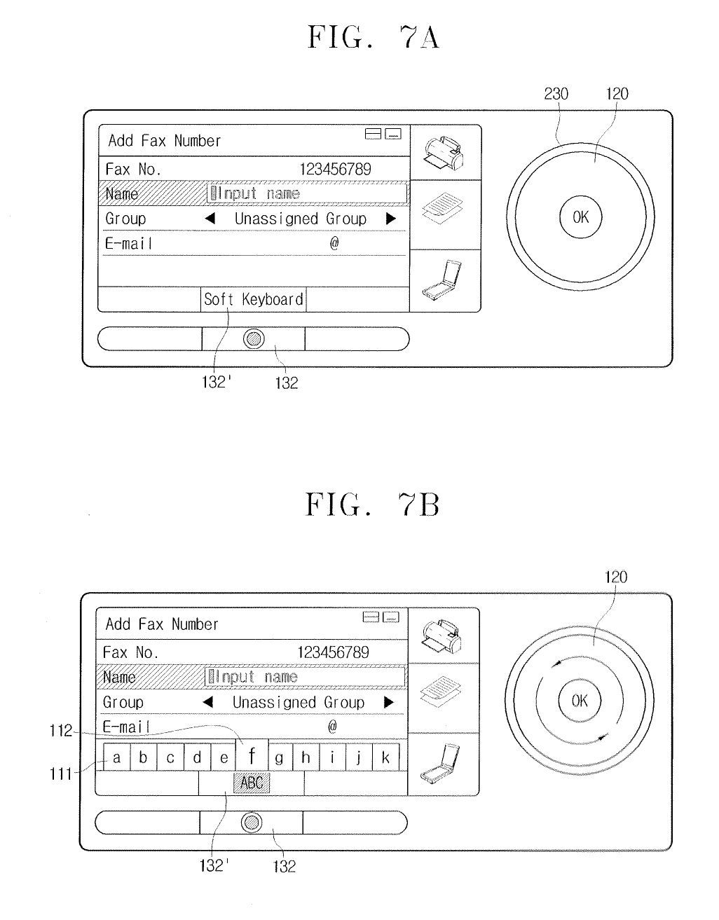

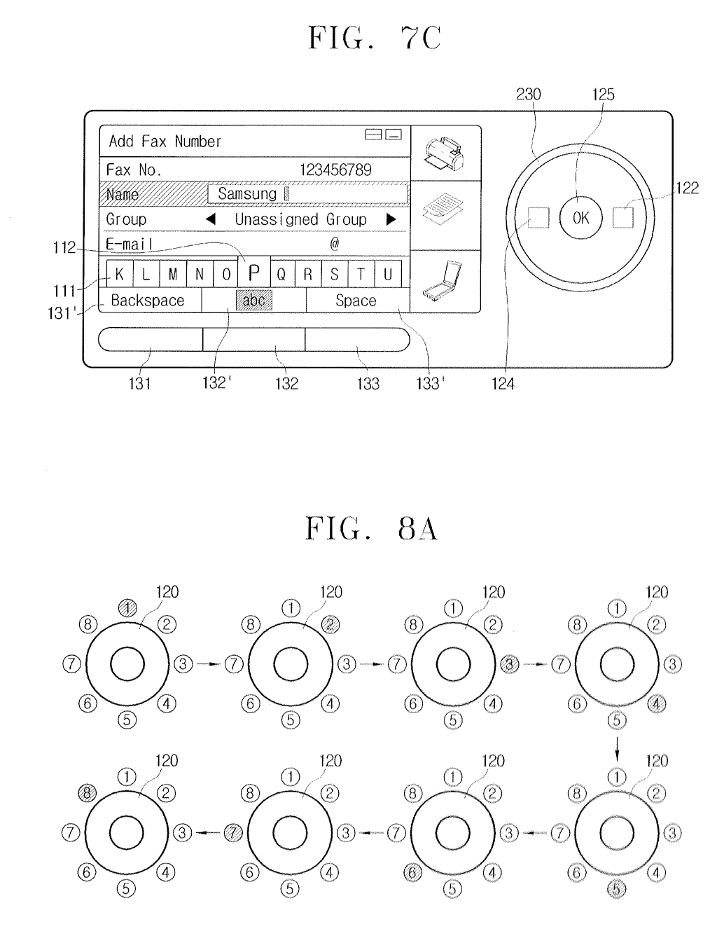

FIGS. 6A to 6C exemplarily illustrate processes of calling a character set, and of converting input modes when character input is solicited by image forming apparatus 300 on the display unit 110.

Referring to FIG. 6A, if character input is solicited to perform a function or task, a message “Soft Keyboard” stating that a soft keyboard function is available may be displayed on a display area corresponding to the central button 132 of the plurality of buttons 131 to 133 on the lower portion of the display unit 110.

FIG. 6B exemplarily illustrates a soft keyboard, namely a character set containing English lower case letters, is displayed on one area of the display unit 110, if the button 132 corresponding to the message “Soft Keyboard” is selected to execute the soft keyboard function when the message “Soft Keyboard” is being displayed on the display unit 110. Additionally, another message “ABC” may be displayed on the display area corresponding to the button 132, indicating that a character set containing English upper case letters can be displayed. Although the character set containing English lower case letters may be displayed first when the soft keyboard function is executed in the exemplary embodiment of the present general inventive concept, the order of character sets to be displayed may be changed (e.g., based on the function or task that solicits character input for the image forming apparatus 300.

FIG. 6C exemplarily illustrates a situation in which the character set containing English upper case letters is displayed on the area of the display unit 110 where the character set containing English lower case letters was previously displayed, if a key corresponding to the message “ABC” is pressed when the message “ABC” is being displayed on the display unit 110. Additionally, another message “abc” may be displayed on the display area corresponding to the button 132, stating that the character set containing English lower case letters can be displayed.

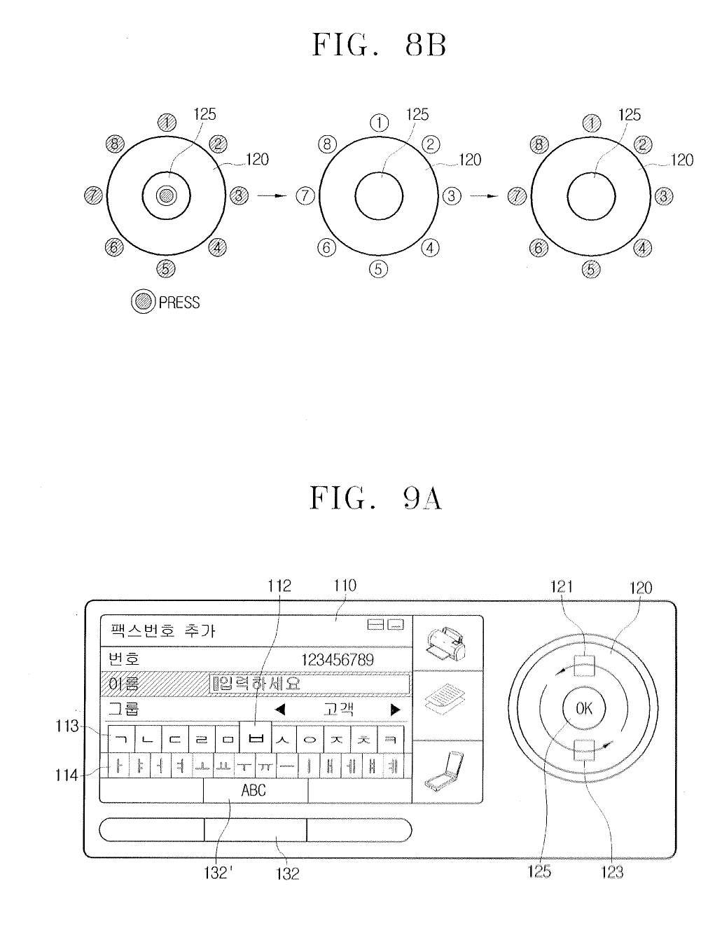

FIGS. 7A to 7C exemplarily illustrate the manipulation of the search wheel 120 when character input is solicited by image forming apparatus 300 on the display unit 110.

In FIG. 7A, if character input is solicited by image forming apparatus 300 (e.g., for a task or function), a message “Soft Keyboard” stating that a soft keyboard function is available may be displayed on a second display area 132′ corresponding to the central button 132 of the plurality of buttons 131 to 133 on the lower portion of the display unit 110.

FIG. 7B exemplarily illustrates a situation in which a character set containing English lower case letters is displayed on a character set area 111 of the display unit 110, if the button 132 corresponding to the message “Soft Keyboard” is selected to execute the soft keyboard function when the message “Soft Keyboard” is being displayed on the second display area 132′. Additionally, another message “ABC” may be displayed on the second display area 132′ corresponding to the button 132, stating that a character set containing English upper case letters can be displayed. If the user rotates the search wheel 120 in a clockwise direction (or in a counterclockwise direction), a cursor 112 appearing on the character set area 111 of the display unit 110 may move to the right (or left).

FIG. 7C exemplarily illustrates a character set containing English upper case letters is displayed on the character set area 111 of the display unit 110, if the button 132 corresponding to the message “ABC” is pressed when the message “ABC” is being displayed on the second display area 132′. The cursor 112 appearing on the character set area 111 of the display unit 110 may move according to the rotation direction of the search wheel 120. For example, if the user selects the input button 125 or other keys (not illustrated) when the cursor 112 indicates English upper case letter “P”, the letter “P” may be selected.

A space function and a backspace function may be mapped, for example, to the buttons 131 and 133 on the lower portion of the display unit 110, respectively, to be used according to the situation. Here, messages notifying about the space and backspace functions may be displayed on a first display area 131′ and a third display area 133′ corresponding to the buttons 131 and 133, respectively.

Alternatively, the space function and backspace function may be mapped to the push areas 122 and 124 on the left and right of the search wheel 120, respectively.

Additionally, the number and locations of buttons 131 to 133 on the lower portion of the display unit 110 may be adjusted, for example, based on the function or task to be performed by image forming apparatus 300, or for any other suitable reason. Various functions other than the space function and backspace function may be mapped to the buttons 131 and 133 or to the push areas 122 and 124.

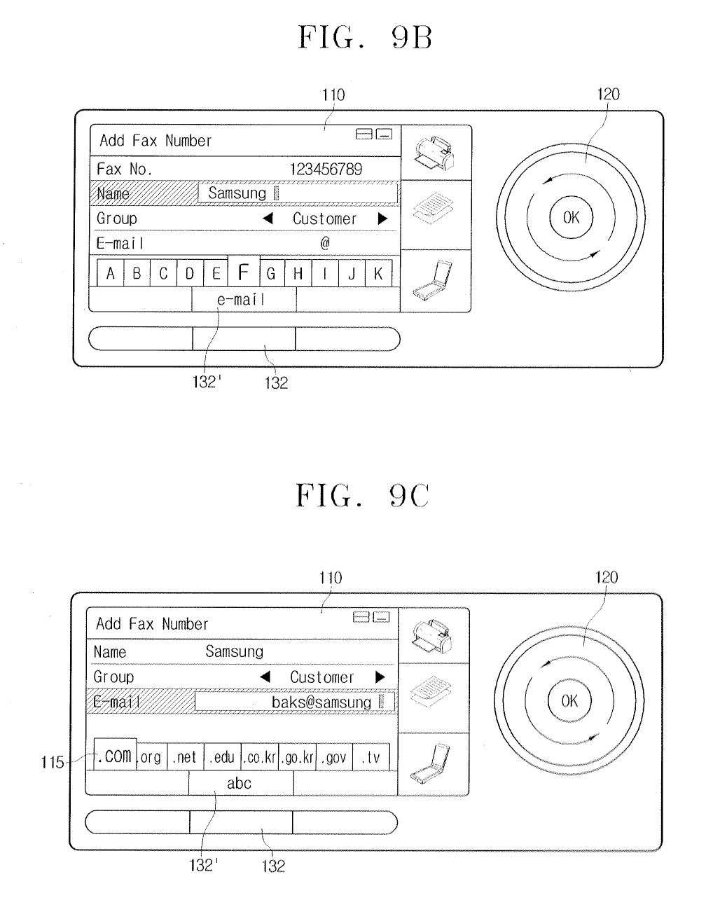

FIGS. 8A and 8B illustrate display patterns of the state indicating unit 230 according to the manipulation of the search wheel 120.

As illustrated in a display pattern of FIG. 8A, if the search wheel 120 is rotated when the soft keyboard is being displayed as illustrated in FIGS. 7A and 7B, the plurality of LEDs #1 to #8 arranged along the outer edge of the search wheel 120 may be made brighter () or dimmer (◯) sequentially in the rotation direction of the search wheel 120.

As illustrated in a display pattern of FIG. 8B, if the input button 125 is pressed when the cursor 112 indicates one from among characters displayed on the soft keyboard, the plurality of LEDs #1 to #8 may concurrently and sequentially be made brighter (), dimmer (◯) and brighter (), so that the user may be notified that a certain character is selected.

The display patterns of FIGS. 8A and 8B are merely exemplary, so the display patterns may change based on the function or task to be performed, or for any other suitable reason.

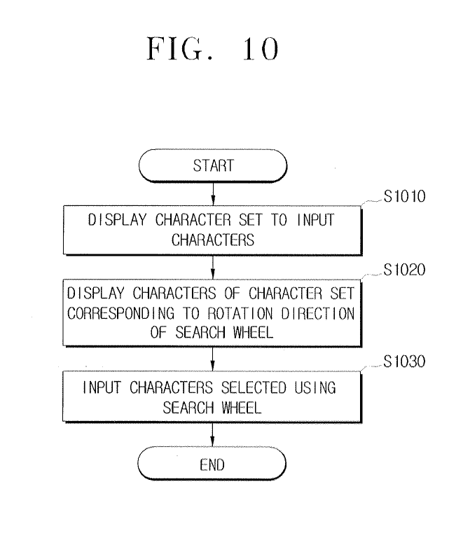

FIGS. 9A and 9B exemplarily illustrate input of Korean syllables is solicited by image forming apparatus 300 on the display unit 110 and a situation in which e-mail address input is required on the display unit 110.

In FIG. 9A, if input of Korean syllables is required, a soft keyboard in which Korean characters are arranged may be displayed on the display unit 110. In this situation, since the user needs to input two or more characters to form a desired Korean syllable, a plurality of Korean character sets may be displayed simultaneously. For example, as illustrated in FIG. 9A, a first character set including characters which may occur initially and a second character set including characters which may occur medially are simultaneously displayed on a first line 113 and a second line 114, respectively.

Additionally, if the user presses the input button 125 when the cursor 112 indicates a character, for example “▪”, as illustrated in FIG. 9A, the character indicated by the cursor 112 may be input. If the user desires to input a geminate consonant “▪”, the input button 125 may be pressed twice when the cursor 112 is currently placed on “▪”, so that “▪” may be input. Alternatively, it is possible to form a character set including geminate consonants.

In this situation, if the user presses the push area 123 on a lower portion of the search wheel 120, the cursor 112 placed on the first line 113 may be moved to the second line 114, so that the cursor 112 may be displayed on the second line 114.

Alternatively, if the user presses the input button 125 when the cursor 112 is placed on the first line 113 to indicate a character, for example “▪”, as illustrated in FIG. 9A, the cursor 112 may automatically move to the second line 114, so that the cursor 112 may be displayed on the second line 114.

Alternatively, if the search wheel 120 rotates out of the range of the first character set on the first line 113, the cursor 112 may automatically move to the second line 114, so that the cursor 112 may appear on the second line 114. Or, the cursor 112 may automatically move to the beginning of the character set on the first line 113.

Additionally, when the cursor 112 moves between the lines 113 and 114, as described above, the type of character sets displayed on each of the lines 113 and 114 may remain the same or may be changed. Accordingly, if the cursor 112 is moved from the first character set to the second character set, the first character set may disappear and the second character set may be displayed on the first line 113 instead of the first character set. In this situation, a third character set following the second character set may be displayed on the second line 114. The third character set includes characters which may occur finally.

Furthermore, after the user selects a character from among the second character set on the second line 114, the third character set may appear.

If a plurality of character sets are simultaneously displayed as illustrated in FIG. 9A, a display state of a currently selected character set may differ from those of other character sets. For example, if the user is searching for a character from the first character set on the first line 113, the first character set may increase in size, or the font type, font size and font color or background color of the first character set may be changed. Alternatively, character sets other than the first character set may be darker or the first character set may be made to flicker. Therefore, it is possible to clearly know which character set is being searched by the user, according to the display state.

Referring FIG. 9B, if the user needs to enter an e-mail address, a message “e-mail” may be displayed on the second display area 132′ corresponding to the button 132 on the display unit 110. Corresponding to the message “e-mail,” a soft keyboard containing top-level domains (TLDs) of e-mail to be displayed (e.g., “.com”, “.org”, “.net”, etc).

As illustrated in FIG. 9C, a soft keyboard 115 containing the TLDs of e-mail may be displayed, and the user may thus select one from among the TLDs using the search wheel 120 and may enter an e-mail address.

FIG. 10 is a flowchart illustrating a method for inputting characters using a rotatable search wheel according to an exemplary embodiment of the present general inventive concept.

In FIG. 10, a plurality of character sets are displayed to input characters in operation S1010. Here, the plurality of character sets are provided in which characters are combined into groups in a predetermined order for each respective script.

For example, it is possible to display a plurality of Korean character sets including characters which may occur initially, medially and finally; a plurality of character sets in which Korean consonants and vowels are arranged; a plurality of character sets in which English upper case and lower case letters are arranged; a plurality of Chinese character sets in which characters are classified into groups according to their radical or according to a pronunciation; or a plurality of character sets in which Japanese hiragana and katakana are arranged; or any other suitable display of an arrangement of a plurality of characters.

If the search wheel is rotated, characters contained in the plurality of character sets are displayed corresponding to the rotation direction of the search wheel in operation S1020.

If the search wheel rotates out of a range of a currently displayed character set, character sets following the currently displayed character set may sequentially displayed, or a cursor on a line on which the character set is currently displayed may move to another line, so that it is possible to search for another character set on the line on which the cursor is disposed.

Alternatively, it is possible to directly move to character sets other than the currently displayed character set using up and down directional keys of the search wheel.

A word or syllable of characters selected by the search wheel is input in operation S1030.

If the search wheel is manipulated, a display pattern may be determined according to the manipulation of the search wheel, and a plurality of LEDs may be made brighter or dimmer according to the determined display pattern, so it is possible to display feedback regarding the manipulation of the search wheel.

Additionally, a function to be executed when at least one button is selected may be displayed on a display area corresponding to the selected button.

According to various exemplary embodiments of the present general inventive concept, a plurality of character sets may be simultaneously displayed, so that a user can input characters using a rotatable search wheel more conveniently and rapidly.

Additionally, since only a soft keyboard including a predetermined range of characters is displayed, a display screen may occupy a small space. Accordingly, it is possible to maintain a screen user interface (UI) related to a character input environment, and compatibility between character input environments can thus be improved.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
a display unit to display a character set;
a search wheel selectable and rotatable, to receive selection, rotation, or selection and rotation input to search for characters to be input from the displayed character set;
an input button; and
a control unit to receive a selection of a character from the displayed character set from the input button.

2. The image forming apparatus of claim 1, further comprising:
at least one selection button disposed on one side of the display unit,
wherein, if the at least one selection button is selected, the control unit controls at least one function corresponding to the selected button.

3. The image forming apparatus of claim 1, wherein, if the search wheel receives rotation input that is out of a range of a character set, the control unit controls the display unit to display the character set cyclically, or to display another character set.

4. The image forming apparatus of claim 1, wherein, if a plurality of character sets are displayed, the control unit controls the display unit so that a display state of a currently selected character set differs from those of other character sets.

5. The image forming apparatus of claim 1, further comprising:
a directional key that receives input for directional movement,
wherein, if a plurality of character sets are displayed and if the directional key is manipulated, the control unit controls the display unit so that the currently selected character set changes to another character set according to the manipulation of the directional key.

6. The image forming apparatus of claim 1, further comprising:
a state indicating unit having a plurality of luminous elements arranged along an outer edge of the search wheel to display feedback corresponding to the manipulation of the search wheel.

7. The image forming apparatus of claim 1, wherein the character set comprises a plurality of character sets in which characters are combined into groups in a predetermined order for each respective script.

8. The image forming apparatus of claim 1, wherein the control unit controls the display unit to display a set of domain names in which preset domain names are arranged to receive input of an e-mail address.

9. A character input apparatus comprising:
a display unit to display a character set;
a search wheel selectable and rotatable, to receive selection, rotation, or selection and rotation input to search for characters in the displayed character set; and
an input button to receive an input selection of the characters selected by the search wheel.

10. The character input apparatus of claim 9, further comprising:
at least one selection button disposed on one side of the display unit,
wherein, if the at least one selection button is selected, the display unit displays at least one function to be actuated corresponding to the selected button.

11. The character input apparatus of claim 9, wherein the display unit displays characters contained in a character set corresponding to a rotation direction of the search wheel.

12. The character input apparatus of claim 9, wherein, if the search wheel receives rotation input out of a range of a character set, the display unit displays the character set cyclically, or displays another character set.

13. The character input apparatus of claim 12, wherein the display unit displays a plurality of character sets so that a display state of a currently selected character set differs from those of other character sets.

14. The character input apparatus of claim 9, further comprising:
a directional key for directional movement,
wherein, if a plurality of character sets are displayed and if the directional key is selected, the display unit changes the currently selected character set to another character set in a direction of the selected directional key.

15. The character input apparatus of claim 9, further comprising:
a state indicating unit having a plurality of luminous elements along an outer edge of the search wheel to display feedback corresponding to the manipulation of the search wheel.

16. The character input apparatus of claim 9, wherein the character set comprises a plurality of character sets in which characters are combined into groups in a predetermined order for each respective script.

17. A method of inputting characters using a search wheel, the method comprising:
displaying a character set in order to input characters;
searching for characters from a character set corresponding to manipulation of the search wheel; and
receiving an input selection of the characters by the search wheel.

18. The method of claim 17, wherein if the search wheel rotates out of a range of a character set, displaying the character set cyclically, or displaying another character set.

19. The method of claim 17, further comprising:
receiving a selection of a directional key; and
changing a currently displayed character set to another character set.

20. The method of claim 17, wherein the displaying the character set comprises displaying a plurality of character sets so that a display state of a currently selected character set differs from those of other character sets.

21. The method of claim 17, further comprising:
determining a display pattern corresponding to the manipulation of the search wheel; and
displaying feedback regarding the manipulation of the search wheel by controlling the illumination of a plurality of luminous elements arranged along an outer edge of the search wheel.

22. The method of claim 17, wherein the character set comprises a plurality of character sets in which characters are combined into groups in a predetermined order for each respective script.

23. A computer recording medium having recorded thereon a program to implement a method of inputting characters using a search wheel, the method comprising:
displaying a character set in order to input characters;
searching for characters from a character set corresponding to manipulation of the search wheel; and
receiving an input selection of the characters by the search wheel.

24. A character input apparatus, comprising:
a search wheel to receive selection, rotation, or selection and rotation input to search for one or more characters displayed on a display; and
a control unit to receive a selection of a character from the search wheel.

25. The apparatus of claim 24, further comprising:
a state indicating unit having one or more illumination devices to illuminate based on the received selection, rotation, or selection and rotation input from the search wheel.

26. A display apparatus, comprising:
a display screen to display a character set;
a search wheel to receive selection, rotation, or selection and rotation input to search for one or more characters displayed on a display; and
a control unit to receive a selection of a character from the search wheel.

27. The apparatus of claim 26, further comprising:
one or more buttons that receive a selection based on at least one message displayed on the display screen,
wherein the control unit receives the selection and controls an operation of the display apparatus based on the selection.

28. The apparatus of claim 26, further comprising:
a state indicating unit having one or more illumination devices to illuminate based on the received selection, rotation, or selection and rotation input from the search wheel.
